(19) United States
(12) Patent Application Publication
(10) Pub. No.: US 2015/0149253 A1
(43) Pub. Date: May 28, 2015

(54) METHOD AND SYSTEM FOR INTEGRATING DEVICE DATA WITH TRANSACTION DATA

(71) Applicant: MasterCard International Incorporated, Purchase, NY (US)

(72) Inventors: Kenny UNSER, Fairfield, CT (US); Nikhil MALGATTI, Stamford, CT (US); Serge BERNARD, Danbury, CT (US); Kent Olof Niklas BERNTSSON, Rye, NY (US); Jean-Pierre GERARD, Croton-On-Hudson, NY (US)

(73) Assignee: MasterCard International Incorporated, Purchase, NY (US)

(21) Appl. No.: 14/259,689

(22) Filed: Apr. 23, 2014

Related U.S. Application Data
(63) Continuation-in-part of application No. 14/088,032, filed on Nov. 22, 2013, now abandoned.

(51) Int. Cl. G06Q 30/02

(52) U.S. Cl. CPC G06Q 30/0204
USPC 705/7.33

(57) ABSTRACT

A method for linking device data to transaction history includes: storing a plurality of consumer profiles, wherein each consumer profile includes data related to a consumer including at least a plurality of consumer characteristics and a plurality of transaction data entries, each transaction data entry corresponding to a payment transaction involving the related consumer; receiving, by a receiving device, a device profile, wherein the device profile includes device data corresponding to a consumer device and a plurality of demographic characteristics associated with a consumer associated with the corresponding consumer device; identifying, by a processing device, at least one consumer profile of the plurality of consumer profiles where at least a predefined number of the included plurality of consumer characteristics correspond to the plurality of demographic characteristics; and associating each of the identified at least one consumer profile with the device data included in the received device profile.

This application is a continuation-in-part of U.S. Non-Provisional application Ser. No. 14/088,032, “Method and System for Integrating Device Data with Transaction Data,” by Kenny Unser et al., filed Nov. 22, 2013. The subject matter of the foregoing is herein incorporated by reference in its entirety.

### FIELD

The present disclosure relates to the linking of device data to transaction history, specifically the linking of consumer device information with consumer transaction history based on a plurality of demographic characteristics.

### BACKGROUND

Transaction data, which may include any useful data captured from a payment transaction, may be useful in a variety of situations. Content providers, such as merchants, retailers, third party offer providers, or advertisers may utilize transaction data to identify targeted content, such as offers and advertisements, to distribute to potential consumers. Transaction data may provide valuable insights as to the potential for a specific consumer to redeem an offer or purchase an advertised product, based on their past transactions. However, in many instances, it may be difficult for an entity to identify the transaction data corresponding to a consumer until after a consumer presents their payment information, which may only occur once a consumer is already transacting. This may be less than ideal for content providers, as they may not be able to identify the consumer until the consumer is already transacting, and thus be unable to influence consumers that may otherwise not transact with them.

Thus, there is a need for a technical solution to identify transaction data corresponding to consumers prior to the point of sale. At the same time, the number of consumers that use computing devices, such as computers, smart phones, smart televisions, tablets, etc. has drastically increased. The types of devices that consumers use may be useful information for content providers. In addition, the types of devices that a consumer use may affect how merchants may engage with these consumers via these devices. For example, a merchant specializing in smart phones and accessories may have greater incentive to target a consumer that is fond of smart phones as opposed to a consumer who prefers tablet computers.

Some methods and systems have been developed for identify computing device associated with consumers. In one such system, device information for a computing device may be obtained during an e-commerce transaction using the computing device, or during browsing of a merchant website using the computing device. Similarly, the computing device information may be obtained when a transaction is conducted using the computing device. Some merchants utilize this information to suggest similar products to a consumer when going back to their website. However, such systems and methods are often closed systems that operate with respect to a specific website, payment card, and/or computing device. As a result, these systems do not provide broad data that includes a consumer's full transaction history or use of multiple devices. In addition, such systems often lack information regarding the consumers themselves, such as demographics, which may add significant value to the transaction and device information.

Thus, there is a need for a technical solution to link transaction history with computing device data using demographic characteristic information.

### SUMMARY

The present disclosure provides a description of systems and methods for linking device data to transaction history and distributing consumer profiles.

A method for linking device data to transaction history includes: storing, in a database, a plurality of consumer profiles, wherein each consumer profile includes data related to a consumer including at least a plurality of consumer characteristics and a plurality of transaction data entries, each transaction data entry corresponding to a payment transaction involving the related consumer; receiving, by a receiving device, a device profile, wherein the device profile includes device data corresponding to a consumer device and a plurality of demographic characteristics associated with a consumer associated with the corresponding consumer device; identifying, by a processing device, at least one consumer profile of the plurality of consumer profiles where at least a predefined number of the included plurality of consumer characteristics correspond to the plurality of demographic characteristics; and associating, in the database, each of the identified at least one consumer profile with the device data included in the received device profile.

A method for distributing a linked consumer profile includes: storing, in a database, a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer; receiving, by a receiving device, a consumer profile request, wherein the consumer profile request includes at least a specific consumer identifier; identifying, in the database, a specific consumer profile where the included consumer identifier corresponds to the specific consumer identifier; transmitting, by a transmitting device, a request for device data, wherein the request for device data includes at least the plurality of consumer characteristics included in the identified specific consumer profile; receiving, by the receiving device, device data; including, in the database, the received device data in the identified specific consumer profile; and transmitting, by the transmitting device, the specific consumer profile including the received device data in response to the received consumer profile request.

A system for linking device data to transaction history includes a database, a receiving device, and a processing device. The database is configured to store a plurality of consumer profiles, wherein each consumer profile includes data related to a consumer including at least a plurality of consumer characteristics and a plurality of transaction data entries, each transaction data entry corresponding to a payment transaction involving the related consumer. The receiving device is configured to receive a device profile, wherein the device profile includes device data corresponding to a consumer device and a plurality of demographic characteristics associated with a consumer associated with the corresponding consumer device. The processing device is configured to: identify at least one consumer profile of the plurality of consumer profiles where at least a predefined number of the included plurality of consumer characteristics correspond to the plurality of demographic characteristics; and associate, in the database, each of the identified at least one consumer profile with the device data included in the received device profile.

A system for distributing a linked consumer profile includes a database, a receiving device, a processing device, and a receiving device. The database is configured to store a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer. The receiving device is configured to receive a consumer profile request, wherein the consumer profile request includes at least a specific consumer identifier. The processing device is configured to identify, in the database, a specific consumer profile where the included consumer identifier corresponds to the specific consumer identifier. The transmitting device is configured to transmit a request for device data, wherein the request for device data includes at least the plurality of consumer characteristics included in the identified specific consumer profile. The receiving device is further configured to receive device data. The processing device is further configured to include, in the database, the received device data in the identified specific consumer profile. The transmitting device is further configured to transmit the specific consumer profile including the received device data in response to the received consumer profile request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIGS. 1A and 1B are high level architectures illustrating systems for linking consumer device data and transaction history in accordance with exemplary embodiments.

FIG. 2 is a block diagram illustrating the processing server of FIG. 1 for the linking of consumer device data and transaction history in accordance with exemplary embodiments.

FIG. 3 is a flow diagram illustrating a method for linking device data with transaction history in a consumer profile in accordance with exemplary embodiments.

FIG. 4 is a flow chart illustrating a method for populating and distributing a consumer profile including device data and transaction history in accordance with exemplary embodiments.

FIG. 5 is a diagram illustrating the linking of consumer device data to transaction history in accordance with exemplary embodiments.

FIGS. 6A and 6B are a flow diagram illustrating a method for distributing offers to a consumer based on linked device and transaction data in accordance with exemplary embodiments.

FIG. 7 is a flow chart illustrating an exemplary method for linking device data to transaction history in accordance with exemplary embodiments.

FIG. 8 is a flow chart illustrating an exemplary method for distributing a linked consumer profile in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems that do not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the systems and methods discussed herein may not possess the PII or be able to decrypt the encrypted PII.

### System for Linking Device Data to Transaction History

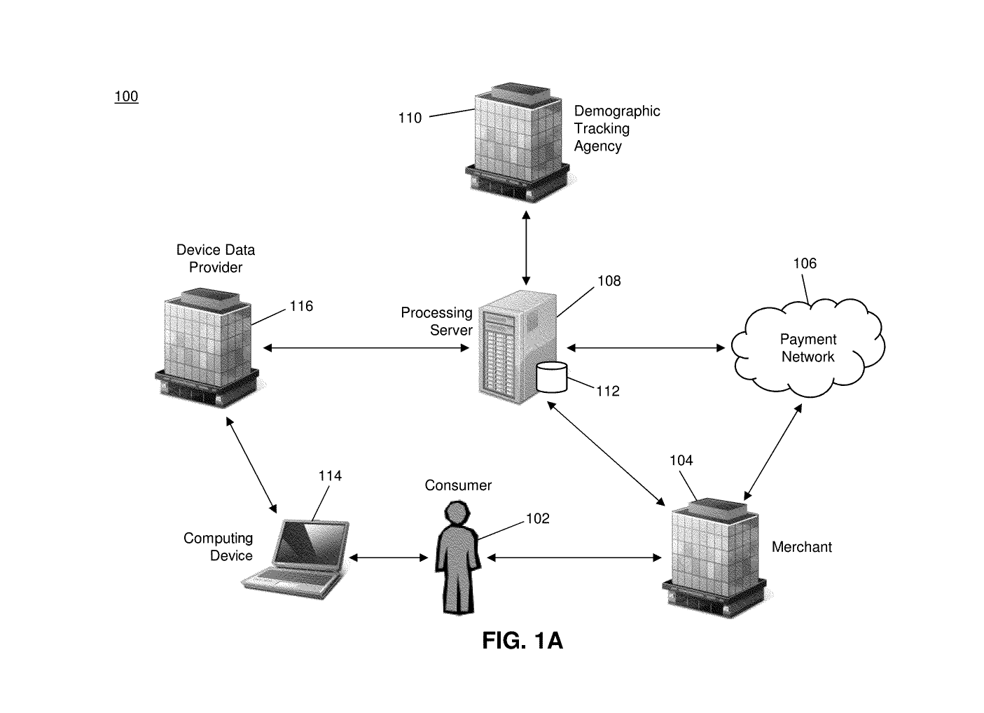

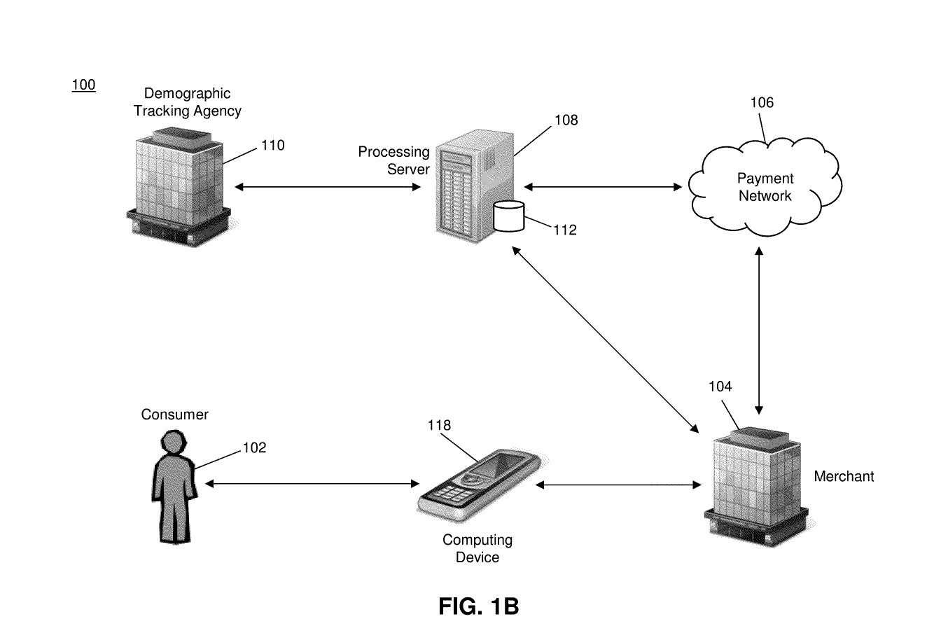

FIG. 1A illustrates a system 100 for linking consumer device data to consumer transaction history.

A consumer 102 may engage in one or more payment transactions at a merchant 104. The payment transaction or transactions may be conducted in person (e.g., at a physical location of the merchant 104), or remotely, such as via the Internet, telephone, by mail, etc. The transaction may be processed via a payment network 106. The payment network 106 may transmit a copy of the authorization request or transaction data included therein to a processing server 108, discussed in more detail below. The processing server 108 may store the transaction data in a consumer profile of a consumer database 112, also discussed in more detail below, associated with the consumer 102. In an exemplary embodiment, the transaction data may only be stored in a consumer profile associated with the particular consumer 102 with the permission of the consumer 102.

The processing server 108 may receive demographic characteristics associated with the consumer 102 from a demographic tracking agency 110 or other third party. The demographic characteristics may include: age, gender, income, marital status, familial status, residential status, occupation, education, zip code, postal code, street address, county, city, state, country, etc. The processing server 108 may store the demographic characteristics in the consumer profile associated with the consumer 102. In an exemplary embodiment, the consumer profile associated with the consumer 102 may not include any personally identifiable information. In some instances, the consumer 102 may be grouped with a plurality of consumers having similar or the same demographic characteristics.

The consumer 102 may use a computing device 114. The computing device 114 may be any type of computing device suitable for performing the functions as discussed herein, such as a desktop computer, laptop computer, notebook computer, tablet computer, cellular phone, smart phone, personal digital assistant, smart television, etc. The computing device 114 may be associated with one or more pieces of device data. The device data may include one or more unique values associated with the computing device 114 used for identification. The values may include an internet protocol address, media access control address, Bluetooth signature, Wi-Fi signature, local area network address, serial number, registration number, device identifier, device name, a combination thereof, and any other suitable value as will be apparent to persons having skill in the relevant art.

In some embodiments, the device data may include data regarding media consumption on the device. For instance, the device data may include data regarding audio or video that is played on the computing device 114, such as songs that are listened to or movies that are watched. In some instances, the device data may include data regarding audio or video that is streamed, such as via a third party source (e.g., Netflix®, Amazon®, Hulu®, etc.) The data may include information regarding the audio or video content itself (e.g., song names, movie names, etc.), and/or may include information associated with the consumed audio or video content, such as artist names, album names, musical genres, publication dates, release dates, director names, producer names, studio names, actor names, award nominations, film genres, etc.

The system 100 may also include a device data provider 116. The device data provider 116 may be configured to receive and store device data associated with the computing device 114 used by the consumer 102. The device data provider 116 may be a web server, an application server, media provider, or any other suitable entity or device configured to perform the functions as disclosed herein. In some instances, the device data provider 116 may be the merchant 104 or otherwise associated with the merchant 104. For example, the merchant 104 may obtain device data identifying the computing device 114 in instances where the consumer 102 may use the computing device 114 to initiate and/or conduct a payment transaction involving the merchant 104, such as an Internet-based transaction or use of the computing device 114 to convey payment information (e.g., as an electronic wallet). In other instances, the payment network 106 may operate as the device data provider 116.

The device data provider 116 may be configured to furnish the stored device data to the processing server 108, which may then store the data in corresponding consumer profiles in the consumer database 112. In some embodiments, the device data provider 116 may provide device data to the processing server 108 associated with demographic characteristics corresponding to the consumer 102 associated with respective device data. In such an embodiment, the processing server 108 may match the device data to one or more consumer profiles based on the demographic characteristics and the consumer characteristics of the one or more consumer profiles. In other embodiments, the processing server 108 may transmit demographic characteristics for one or more consumer profiles to the device data provider 116. The device data provider 116 may then identify device data corresponding to the consumer characteristics, and distribute the identified device data to the processing server 108. The processing server 108 may then store the device data in the corresponding one or more consumer profiles. Methods for identifying correspondence between demographic characteristics and consumer characteristics are discussed in more detail below. Additional methods for obtaining the device data corresponding to computing devices 114 that are associated with consumers 102, without personally identifying the consumers 102, will be apparent to persons having skill in the relevant art.

The processing server 108 may then have transaction history and device data for a consumer 102 linked together in a consumer profile associated with the consumer 102. In an exemplary embodiment, the consumer profile may not include any personally identifiable information for the consumer 102, except with the express consent of the consumer 102. By linking transaction history with device data, the processing server 108, or a third party, such as an advertiser, that may receive the data from the processing server 108, may be able to obtain significantly more data from a consumer's combined device and transaction history than utilizing either set of data alone. In one such example, the third party may identify a device, then, using the linked profile, identify the characteristics and transaction history for a corresponding consumer, and may thus identify content to be distributed to the device based on that data. In another example, the third party may identify characteristics of a consumer, such as demographics of their regular or target consumers, and then receive device data including media consumption as well as transaction data for consumers matching those characteristics. Such information may enable the third party to learn more about the consumers in terms of not only spending habits, but also how they consume media, which may provide for a valuable basis for developing future products, advertisements, etc.

Another beneficial use of the linking of device data to transaction history may be illustrated in the alternative embodiment of the system 100 illustrated in FIG. 1B. In the alternative system 100, the consumer 102 may possess a mobile computing device 118. The mobile computing device 118 may have one or more pieces of identifying device data associated with the mobile computing device 118. For example, the mobile computing device 118 may have a unique media access control (MAC) address.

The consumer 102 may conduct a payment transaction with the merchant 104 using the mobile computing device 118. The payment transaction may be a standard Internet transaction (e.g., via a website or application program of the merchant 104) or may be a transaction conducted in person where payment information is conveyed using the mobile computing device 118. Methods of conveying payment information using a mobile computing device 118 will be apparent to persons having skill in the relevant art and may include using near field communication, machine-readable codes, etc.

The merchant 104 may receive the payment information from the mobile computing device 118 for the transaction, as well as the device data associated with the mobile computing device 118. The merchant 104 may then transmit the device data to the processing server 108. The processing server 108 may identify a linked consumer profile stored in the consumer database 112 that includes the device data corresponding to the mobile computing device 118. The linked consumer profile may include consumer characteristics (e.g., provided by the demographic tracking agency 110) and transaction data (e.g., provided by the payment network 106). The processing server 108 may then transmit the linked consumer profile and/or the data included therein to the merchant 104.

The merchant 104 may then utilize the received consumer profile. In one example, the merchant 104 may operate a loyalty program based on past transaction history at the merchant 104 based on the transaction data included in the profile. In another example, the merchant 104 may identify offers to distribute to the consumer 102 based on the consumer's transaction history, media consumption, and/or characteristics. Additional applications of the linked consumer profile will be apparent to persons having skill in the relevant art.

As discussed in more detail below, device data may be grouped among a plurality of consumers 102 to avoid the use of personally identifiable information. In such an instance, a plurality of consumers 102 having similar consumer characteristics may be grouped together into a single profile. For example, a profile may include consumers 102 that are male, between the ages of 32 and 35, having an income between $50,000 and $75,000, and living in a specific zip code. In such an example, the profile may correspond to a number of consumers, such that the device data included in the profile may correspond to each of the consumers and thus not be personally identifiable to any specific consumer. Additional methods and systems for associating consumers based on consumer characteristics and the grouping of consumers for privacy of the consumers can be found in U.S. patent application Ser. No. 13/437,987, entitled “Protecting Privacy in Audience Creation,” to Curtis Villars et al., filed Apr. 3, 2012, which is herein incorporated by reference in its entirety.

### Processing Device

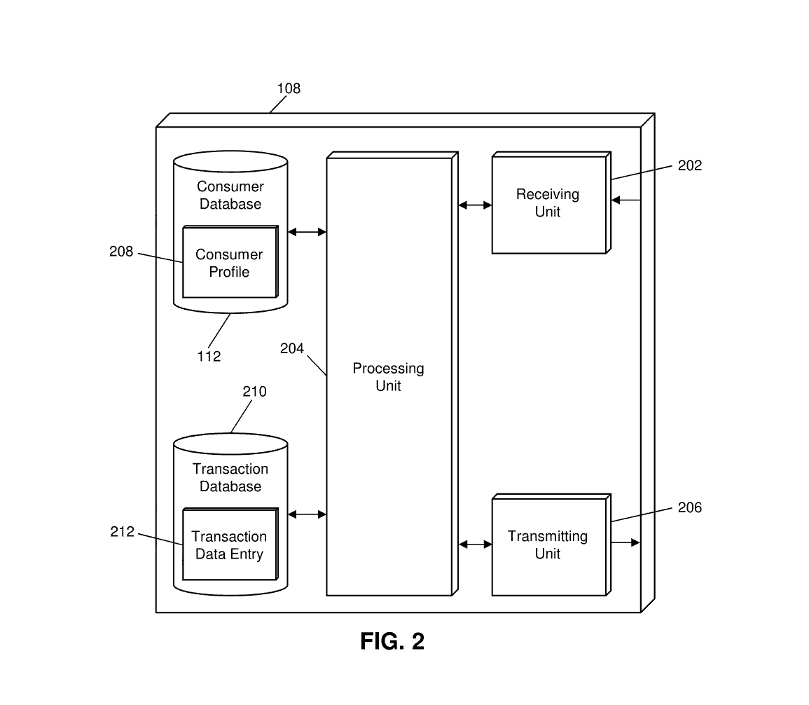

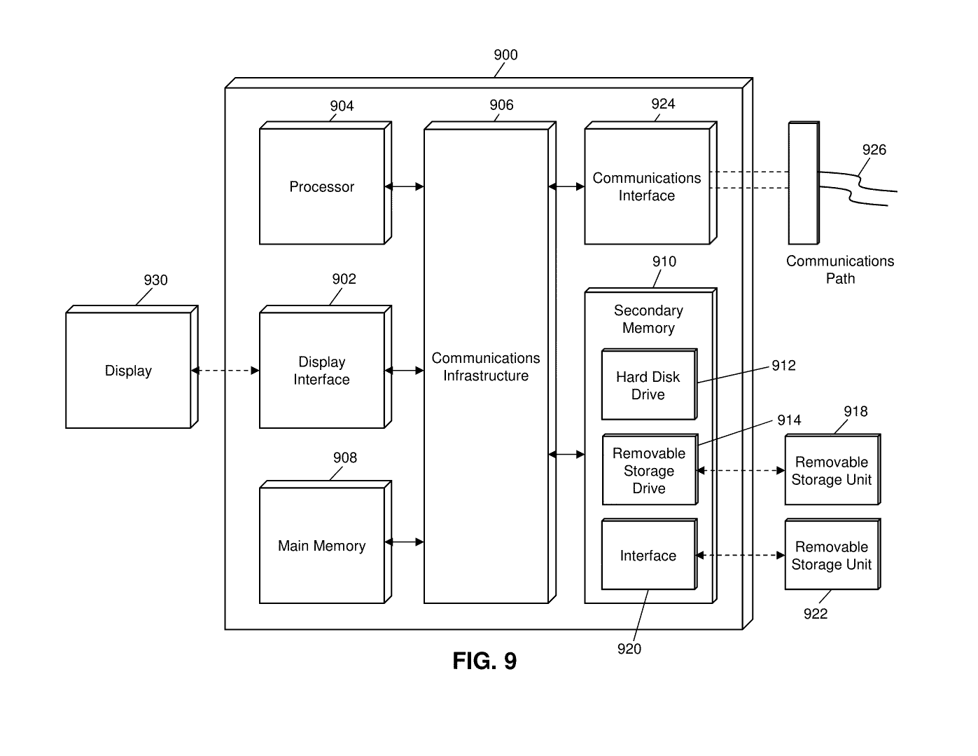

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 900 illustrated in FIG. 9 and discussed in more detail below may be a suitable configuration of the processing server 108.

The processing server 108 may include a receiving unit 202. The receiving unit 202 may be configured to receive data over one or more networks via one or more network protocols. The receiving unit 202 may be configured to receive transaction data, demographic characteristic data, and device data.

The processing server 108 may also include a processing unit 204. The processing unit 204 may be configured to store received transaction data in a transaction database 210 as one or more transaction data entries 212. Each transaction data entry 212 may include data related to a corresponding payment transaction, such as a consumer identifier, merchant identifier, transaction amount, transaction time and/or date, geographic location, merchant name, product data, coupon or offer data, a point-of-sale identifier, or other suitable information as will be apparent to persons having skill in the relevant art. In some embodiment, each transaction data entry may also include demographic characteristics for a consumer (e.g., consumer characteristics) involved in the corresponding payment transaction.

The processing unit 204 may also be configured to store a plurality of consumer profiles 208 in the consumer database 112. Each consumer profile 208 may include data related to a consumer (e.g., the consumer 102), including at least a plurality of consumer characteristics. In some embodiments, each consumer profile 208 may also include a plurality of transaction data entries 212. In an exemplary embodiment, each consumer profile 208 may not include personally identifiable information unless expressly consented to by the corresponding consumer 102. In some embodiments, each consumer profile 208 may be associated with a specific set of consumer characteristics and may accordingly be related to a generic consumer of those characteristics rather than an actual consumer 102.

The processing unit 204 may be configured to link consumer profiles 208 with transaction data entries 212 based on demographic characteristics. The processing unit 204 may also be configured to link consumer profiles 208 including transaction data entries 212 with device data received by the receiving unit 202. The processing unit 204 may be configured to link the consumer profiles 208 with the device data via demographic characteristics included in the consumer profiles 208 and in the received device data. In some instances, the processing unit 204 may match device data to transaction history based on a predefined number of demographic characteristics (e.g., at least the predefined number of characteristics must match). In other instances, transaction history and device data may be matched via algorithms or other systems and methods that will be apparent to persons having skill in the relevant art. In some embodiments, the processing unit 204 may store the received device data in the linked consumer profile 208.

The processing server 108 may also include a transmitting unit 206. The transmitting unit 206 may be configured to transmit data over one or more networks via one or more network protocols. The transmitting unit 206 may be configured to transmit requests for data, such as to the demographic tracking agency 110 and/or the device data provider 116. The transmitting unit 206 may also be configured to transmit transaction history and/or device data, or a consumer profile 208 including linked transaction history and device data, in response to a request from a third party (e.g., an advertiser).

### Method for Linking Device Data to Transaction History

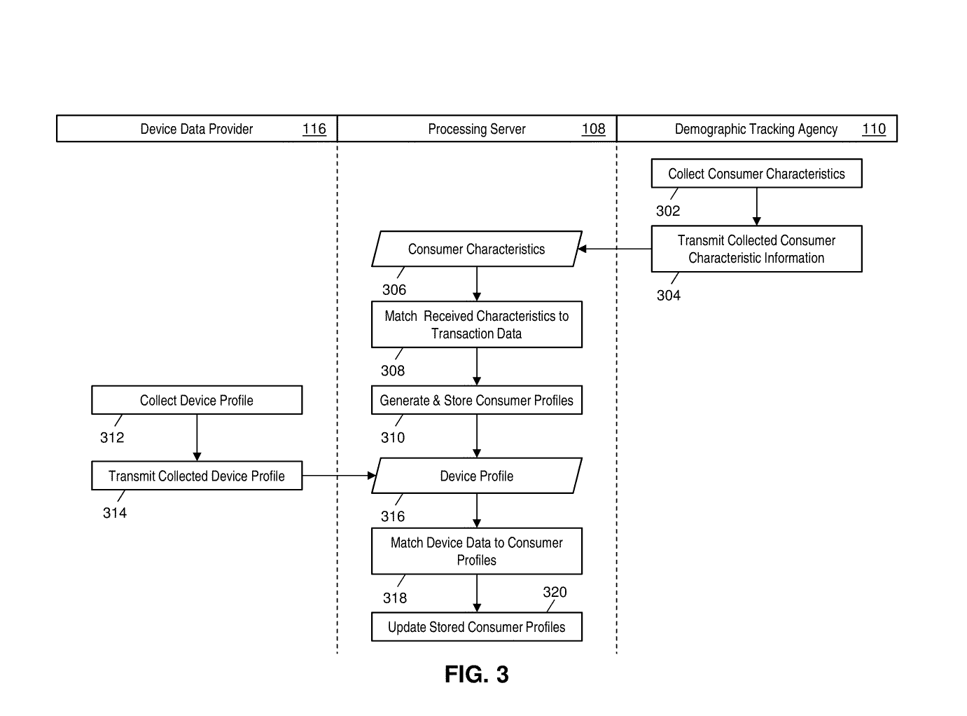

FIG. 3 illustrates a method for linking consumer device data to transaction history.

In step 302, the demographic tracking agency 110 may collect demographic characteristics for one or more consumers. Methods and systems for collecting demographic characteristics will be apparent to persons having skill in the relevant art. The demographic tracking agency 110 may collect the information and may, in step 304, transmit the collected demographic characteristic information to the processing server 108.

In step 306, the processing server 108 may receive the demographic characteristic information. In step 308, the processing unit 204 of the processing server 108 may match the received demographic characteristic information to transaction data entries 212 included in the transaction database 210. In step 310, the processing unit 204 may generate consumer profiles 208 for matched transaction history and demographic characteristics (e.g., consumer characteristics) and store the consumer profiles 208 in the consumer database 112. In an exemplary embodiment, the processing unit 204 may bucket or otherwise modify the consumer characteristic information and/or transaction data to render the corresponding consumer profile 208 not personally identifiable. In some instances, the processing unit 204 may group transaction data entries 212 for multiple consumers sharing consumer characteristics into a single consumer profile 208.

In step 312, the device data provider 116 may store device profiles for one or more computing devices 114 associated with consumers 102, the device profiles including device data and a plurality of demographic characteristics that are associated with the corresponding one or more consumers 102. In step 314, the device data provider 116 may transmit the collected device profile to the processing server 108. The processing server 108 may, in step 316, receive the device profile from the device data provider 116.

In step 318, the processing unit 204 of the processing server 108 may match the received device data to the consumer profiles 208 based on matching of the demographic and consumer characteristics. In step 320, the processing unit 204 may update the consumer profiles 208 to include and/or be associated with the matched device data.

### Method for Distributing a Consumer Profile

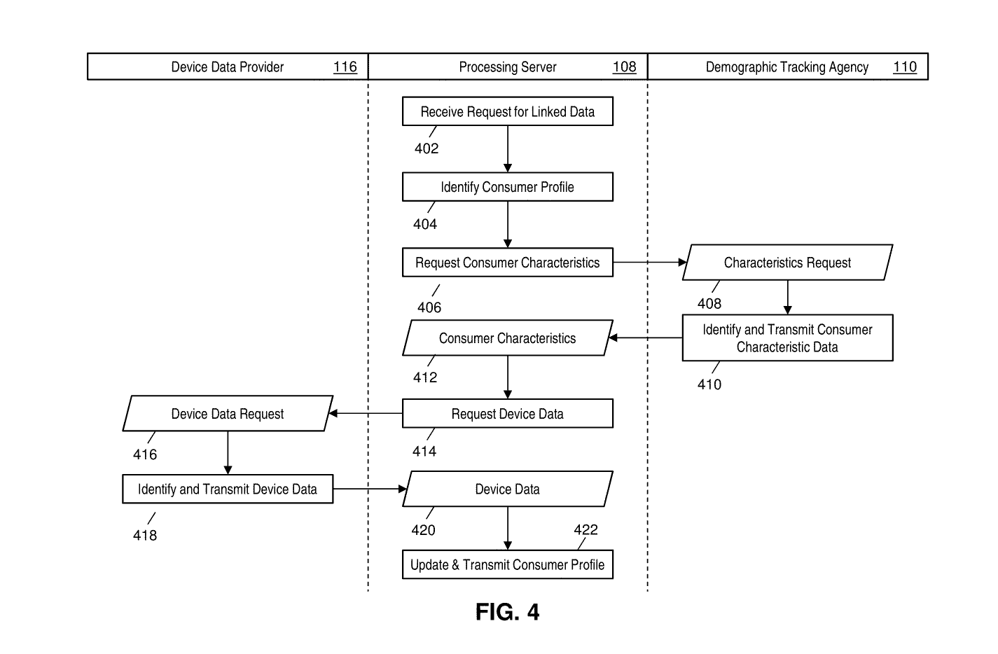

FIG. 4 illustrates a method for distributing a consumer profile including linked device data and transaction history.

In step 402, the processing server 108 may receive (e.g., via the receiving unit 202) a request for linked consumer device and transaction data. The request for linked data may include a consumer identifier or other identifying information, such as consumer characteristics. In step 404, the processing unit 204 may identify, in the consumer database 112, a consumer profile 208 based on the information included in the request.

In step 406, the processing server 108 may transmit (e.g., via the transmitting unit 206), a request for consumer characteristics for the consumer associated with the identified consumer profile 208. In step 408, the demographic tracking agency 110 may receive the request, and, in step 410, may identify consumer characteristics associated with the consumer and transmit them back to the processing server 108. In step 412, the processing server 108 may receive the consumer characteristics associated with the consumer 102 related to the identified consumer profile 208.

In step 414, the processing server 108 may request device data for the consumer 102 (e.g., corresponding to the associated computing device 114) from the device data provider 116. The device data request may include the previously received consumer characteristics. In step 416, the device data provider 116 may receive the device data request, and, in step 418, identify device data associated with the consumer characteristics received in the device data request and transmit the device data to the processing server 108. The processing server 108 may receive the device data in step 420.

In step 422, the processing server 108 may update the consumer profile 208 to include the received device data, and may transmit the consumer profile 208 and/or the included transaction history and device data as a response to the initially received request. In an exemplary embodiment, the consumer profile 208 may not include any personally identifiable information for the related consumer 102. In other embodiments, the processing server 108 may remove and/or render personally unidentifiable any personally identifiable information included in the consumer profile 208.

### Linking Device Data to Transaction History

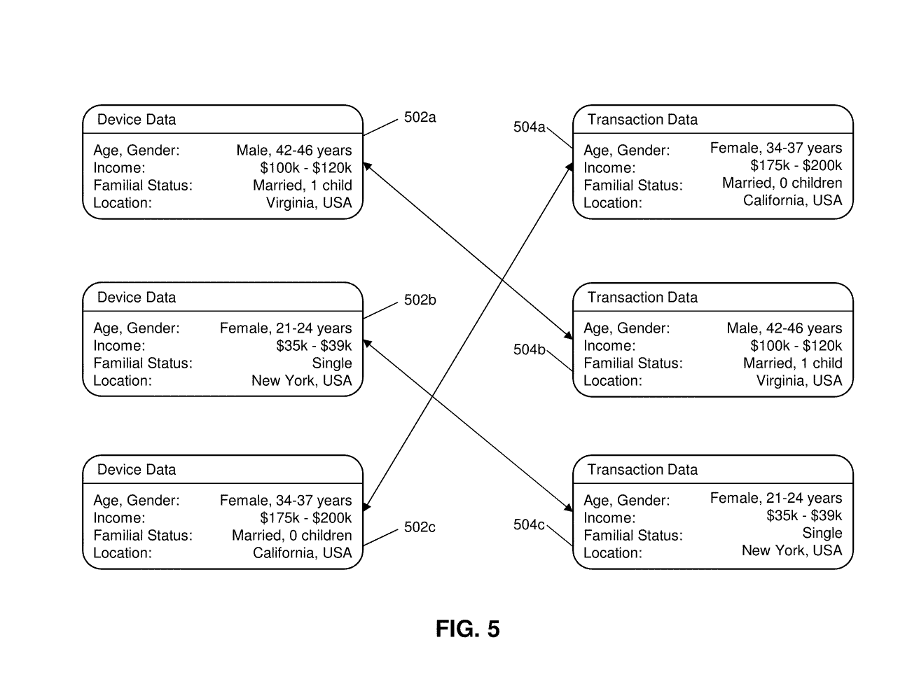

FIG. 5 illustrates the linking of consumer device data 502 to transaction history 504 using demographic characteristics.

Each set of device data 502, illustrated in FIG. 5 as device data 502a, 502b, and 502c, may correspond to a computing device 114 associated with a consumer 102 and include a plurality of demographic characteristics associated with the consumer 102. For example, device data 502a may corresponds to the computing device 114 of a consumer 102 that is a male, of an age between 42 and 46 years old, has an income between $100,000 and $120,000, is married, has one child, and lives in Virginia. In some embodiments, the device data 502a may correspond to a plurality of consumers each having the same demographic characteristics data.

Each set of transaction data 504, illustrated in FIG. 5 as transaction data 504a, 504b, and 504c, may correspond to a consumer 102 or a plurality of consumers 102, and include a plurality of consumer characteristics associated with the corresponding consumer or consumers 102. For example, transaction data 504a may correspond to a consumer 102 that is a female, of an age between 34 and 37 years old, has an income between $175,000 and $200,000, is married, has no children, and lives in California.

The processing unit 204 of the processing server 108 may identify the demographic characteristics for each of the device data 502 and transaction data 504 and match the two sets of data based on common demographic and consumer characteristics. For example, in the example illustrated in FIG. 5, the processing unit 204 may match device data 502a with transaction data 504b, device data 502b with transaction data 504c, and device data 502c with transaction data 504a. The processing unit 204 may then store the linked data in one or more consumer profiles 208 including the corresponding consumer characteristics.

In some embodiments, the demographic characteristics for the device data 502 may not directly correspond to the consumer characteristics for the transaction data 504. In such an instance, the processing unit 204 may be configured to link the data based on a predefined number of matching characteristics. For example, if the transaction data 504b was associated with a consumer 102 having two children (instead of the one child illustrated in FIG. 5), while the device data 502a is associated with a consumer 102 having only one child, the processing unit 204 may still link the two sets of data because the sets have at least five matching demographic characteristics including age, gender, income, marital status, and geographic location.

### Application of Linked Profiles for Offer Distribution

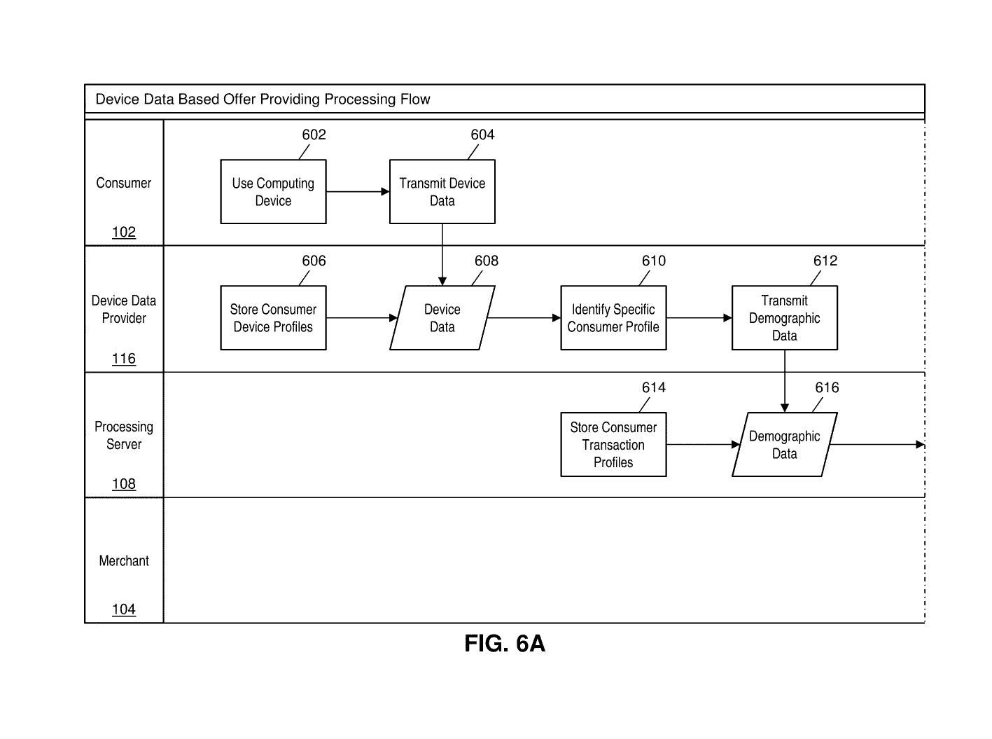

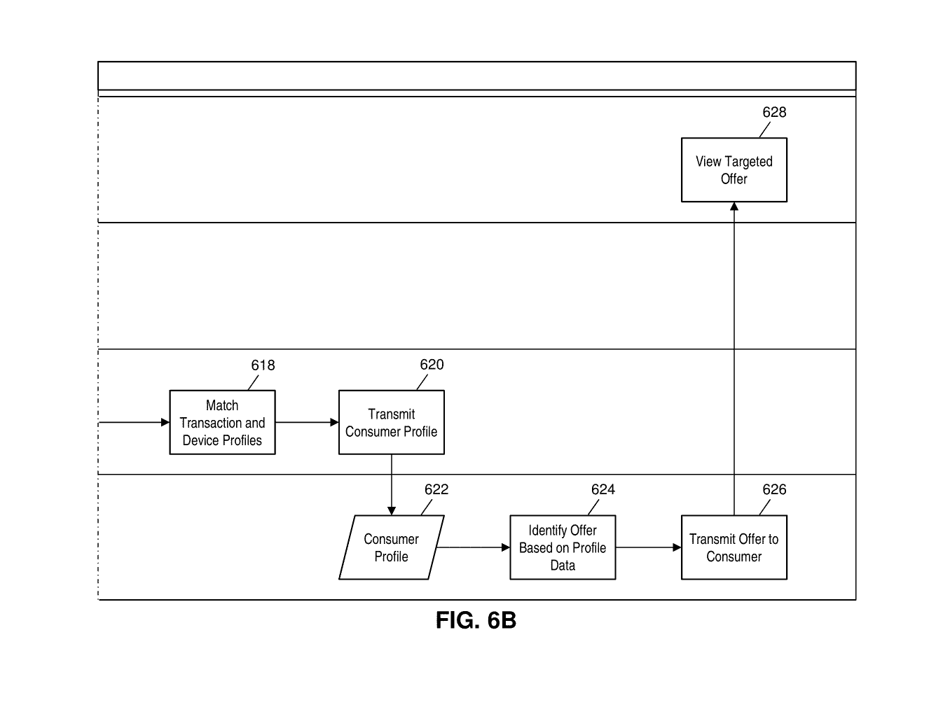

FIGS. 6A and 6B illustrate a method for the distribution of offers to a consumer 102 based on a linked consumer profile including transaction history and device data generated and/or distributed using the methods and systems as discussed herein. It will be apparent to persons having skill in the relevant art that the distribution of offers based on a linked consumer profile is used as an illustration of a potential application of the systems and methods discussed herein only, and that there may be a variety of additional applications of linked transaction and device data.

In step 602, the consumer 102 may use an associated computing device 114. The computing device 114 may be associated with device data, such as a MAC address associated with the specific computing device 114. In step 604, the device data of the computing device 114 associated with the consumer 102 may be transmitted to the device data provider 116. In some instances, the computing device 114 may be the device data provider 116.

In step 606, the device data provider 116 may store a device profile for one or more consumers 102. The device profile may include device data for a computing device 114 associated with each respective consumer 102 and may further include a plurality of demographic characteristics associated with the respective consumer 102. In step 608, the device data provider 116 may receive the device data supplied by the consumer 102 and/or the computing device 114. In step 610, the device data provider 116 may identify the specific consumer device profile corresponding to the consumer 102 based on the supplied device data. Methods and systems for identifying a profile based on device data will be apparent to persons having skill in the relevant art.

In step 612, the device data provider 116 may transmit the device data and plurality of demographic characteristics included in the consumer device profile to the processing server 108. In step 614, the processing server 108 may store a plurality of consumer profiles 208 associated with consumers 102 including transaction data entries 212 corresponding to payment transactions involving the respective consumers 102 and consumer characteristics associated with the respective consumers 102. In step 616, the processing server 108 may receive the plurality of demographic characteristics and device data from the device data provider 116.

In step 618, the processing server 108 may match the received device data to one or more consumer profiles 208 based on a correspondence between the received demographic characteristics and the consumer characteristics included in each of the respective one or more consumer profiles 208. In some instances, the received device profile may be associated with consumer profiles 208 associated with multiple consumers 102, such as if consumers 102 are grouped together to protect consumer privacy and security.

In step 620, the processing server 108 may transmit the linked consumer profile to the merchant 104. It will be apparent to persons having skill in the relevant art that, in the embodiment illustrated in FIGS. 6A and 6B, the merchant 104 may be replaced by an offer provider, content provider, the computing device 114, a mobile network operator, or other suitable entity. In step 622, the merchant 104 may receive the linked consumer profile.

In some embodiments, the merchant 104 may first submit a request for a consumer profile to the processing server 108. The request may include device data, such as captured at the point of sale or premises of the merchant 104 (e.g., as used in a payment transaction, as delivered to the computing device 114, etc.), or used for interaction with the merchant 104 (e.g., visiting a website of the merchant 104, requesting audio or video, etc.). The processing server 108 may subsequently identify the linked consumer profile including the device data, and then transmit the identified consumer profile in step 620 to the merchant 104.

In step 624, the merchant 104 may identify an offer based on profile data, including the characteristics and transaction history. Methods and systems for identifying an offer based on transaction history and demographics will be apparent to persons having skill in the relevant art. In step 626, the merchant 104 may transmit the identified offer to the computing device 114 associated with the consumer 102. In step 628, the consumer 102 may receive and view the targeted offer.

### Exemplary Method for Linking Device Data to Transaction History

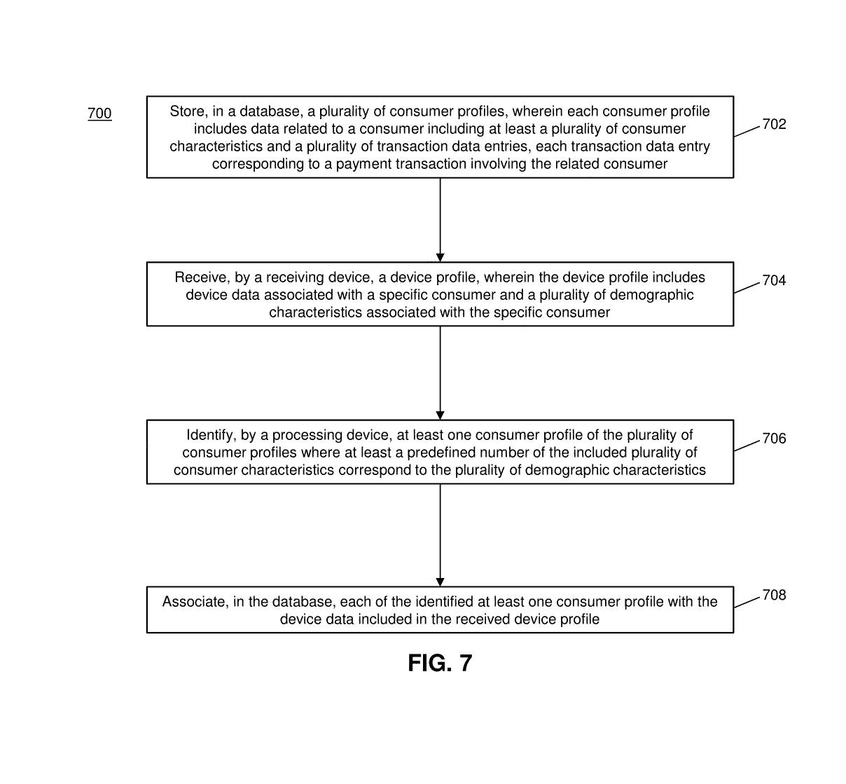

FIG. 7 illustrates a method 700 for linking consumer device data to transaction history using demographic characteristics.

In step 702, a plurality of consumer profiles (e.g., the consumer profiles 208) may be stored in a database (e.g., the consumer database 112), wherein each consumer profile 208 includes data related to a consumer (e.g., the consumer 102) including at least a plurality of consumer characteristics and a plurality of transaction data entries (e.g., transaction data entries 212), each transaction data entry 212 corresponding to a payment transaction involving the related consumer 102. In some embodiments, the plurality of consumer characteristics may not be personally identifiable.

In one embodiment, the plurality of consumer characteristics may include at least one of: age, gender, income, marital status, familial status, residential status, occupation, education, zip code, postal code, street address, county, city, state, and country. In some embodiments, each transaction data entry 212 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 704, a device profile may be received, by a receiving device (e.g., the receiving unit 202), wherein the device profile includes device data corresponding to a consumer device (e.g., the computing device 114) and a plurality of demographic characteristics associated with a consumer 102 associated with the corresponding consumer device 114. In one embodiment, the device data may include at least one of: an internet protocol address, media access control address, Bluetooth signature, WiFi signature, local area network address, serial number, registration number, device identifier, manufacturer number, video data, audio data, streaming data, media consumption data, and device name. In some embodiments, the plurality of demographic characteristics may not be personally identifiable.

In step 706, at least one consumer profile 208 of the plurality of consumer profiles may be identified, by a processing device (e.g., the processing unit 204), where at least a predefined number of the included plurality of consumer characteristics correspond to the plurality of demographic characteristics. In step 708, each of the identified at least one consumer profiles 208 may be associated, in the database 112, with the device data included in the received device profile.

### Exemplary Method for Distributing a Linked Consumer Profile

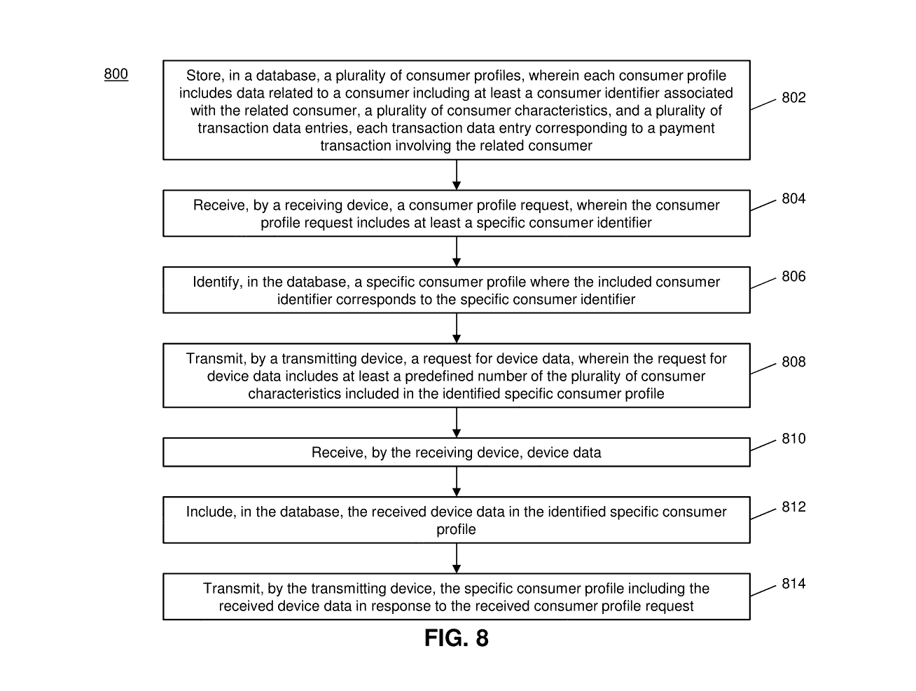

FIG. 8 illustrates a method 800 for distributing a consumer profile including device data and transaction history linked based on demographic characteristics.

In step 802, a plurality of consumer profiles (e.g., the consumer profiles 208) may be stored, in a database (e.g., the consumer database 112), wherein each consumer profile 208 includes data related to a consumer (e.g., the consumer 102), including at least a consumer identifier associated with the related consumer 102, a plurality of consumer characteristics, and a plurality of transaction data entries (e.g., transaction data entries 212), each transaction data entry 212 corresponding to a payment transaction involving the related consumer 102. In some embodiments, the plurality of demographic characteristics may not be personally identifiable.

In one embodiment, the plurality of consumer demographic characteristics may include at least one of: age, gender, income, marital status, familial status, residential status, occupation, education, zip code, postal code, street address, county, city, state, and country. In some embodiments, each transaction data entry 212 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 804, a consumer profile request may be received, by a receiving device (e.g., the receiving unit 202), wherein the consumer profile request includes at least a specific consumer identifier. In step 806, a specific consumer profile 208 may be identified, in the database 112, where the included consumer identifier corresponds to the specific consumer identifier. In step 808, a request for device data may be transmitted by a transmitting device (e.g., the transmitting unit 206), wherein the request for device data includes at least the plurality of consumer characteristics included in the identified specific consumer profile 208.

In step 810, the receiving device 202 may receive device data. In one embodiment, the request for device data may further include a predefined number, the received device data may be associated with demographic characteristics, and a number of the plurality of consumer characteristics included in the specific consumer profile 208 that correspond to the plurality of demographic characteristics is at least the predefined number. In a further embodiment, the plurality of demographic characteristics may not be personally identifiable. In some embodiments, the device data may include at least one of: an internet protocol address, media access control address, Bluetooth signature, WiFi signature, local area network address, serial number, registration number, device identifier, manufacturer number, video data, audio data, streaming data, media consumption data, and device name.

In step 812, the received device data may be included, in the database 112, in the identified specific consumer profile 208. In step 814, the specific consumer profile 208 including the received device data may be transmitted, by the transmitting device 206, in response to the received consumer profile request.

### Computer System Architecture

FIG. 9 illustrates a computer system 900 in which embodiments of the present disclosure, or portions thereof, may be implemented as computer-readable code. For example, the processing server 108 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, 6A, 6B, 7, and 8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 3, 4, 6A, 6B, 7, and 8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for linking device data to transaction history and distributing linked consumer profiles. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for linking device data to transaction history, comprising:
storing, in a database, a plurality of consumer profiles, wherein each consumer profile includes data related to a consumer including at least a plurality of consumer characteristics and a plurality of transaction data entries, each transaction data entry corresponding to a payment transaction involving the related consumer;
receiving, by a receiving device, a device profile, wherein the device profile includes device data corresponding to a consumer device and a plurality of demographic characteristics associated with a consumer associated with the corresponding consumer device;
identifying, by a processing device, at least one consumer profile of the plurality of consumer profiles where at least a predefined number of the included plurality of consumer characteristics correspond to the plurality of demographic characteristics; and
associating, in the database, each of the identified at least one consumer profile with the device data included in the received device profile.

2. The method of claim 1, wherein the plurality of consumer characteristics includes at least one of: age, gender, income, marital status, familial status, residential status, occupation, education, zip code, postal code, street address, county, city, state, and country.

3. The method of claim 1, wherein each transaction data entry includes at least transaction data, a consumer identifier associated with the related consumer, and a merchant identifier associated with a merchant involved in the corresponding payment transaction.

4. The method of claim 3, wherein the transaction data includes at least one of: a transaction amount, product data, transaction time and/or date, geographic location, coupon data, and point-of-sale identifier.

5. The method of claim 1, wherein the plurality of consumer characteristics are not personally identifiable.

6. The method of claim 1, wherein the device data includes at least one of:
an internet protocol address, a media access control address, a Bluetooth signature, a Wi-Fi signature, a local area network address, a serial number, a registration number, a device identifier, a manufacturer number, video data, audio data, streaming data, media consumption data, and device name.

7. The method of claim 1, wherein the plurality of demographic characteristics are not personally identifiable.

8. A method for distributing a linked consumer profile, comprising:
storing, in a database, a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer;
receiving, by a receiving device, a consumer profile request, wherein the consumer profile request includes at least a specific consumer identifier;
identifying, in the database, a specific consumer profile where the included consumer identifier corresponds to the specific consumer identifier;
transmitting, by a transmitting device, a request for device data, wherein the request for device data includes at least a predefined number of the plurality of consumer characteristics included in the identified specific consumer profile;
receiving, by the receiving device, device data;
including, in the database, the received device data in the identified specific consumer profile; and
transmitting, by the transmitting device, the specific consumer profile including the received device data in response to the received consumer profile request.

9. The method of claim 8, wherein the device data is associated with a plurality of demographic characteristics, and at least the predefined number of the plurality of consumer characteristics included in the specific consumer profile correspond to the plurality of demographic characteristics.

10. The method of claim 8, wherein the plurality of consumer characteristics includes at least one of: age, gender, income, marital status, familial status, residential status, occupation, education, zip code, postal code, street address, county, city, state, and country.

11. The method of claim 8, wherein each transaction data entry includes at least transaction data, a consumer identifier associated with the related consumer, and a merchant identifier associated with a merchant involved in the corresponding payment transaction.

12. The method of claim 11, wherein the transaction data includes at least one of: a transaction amount, product data, transaction time and/or date, geographic location, coupon data, and point-of-sale identifier.

13. The method of claim 8, wherein the plurality of consumer characteristics are not personally identifiable.

14. The method of claim 8, wherein the device data includes at least one of: an internet protocol address, a media access control address, a Bluetooth signature, a Wi-Fi signature, a local area network address, a serial number, a registration number, a device identifier, a manufacturer number, video data, audio data, streaming data, media consumption data, and device name.

15. The method of claim 8, wherein the plurality of demographic characteristics are not personally identifiable.

16. A system for linking device data to transaction history, comprising:
a database configured to store a plurality of consumer profiles, wherein each consumer profile includes data related to a consumer including at least a plurality of consumer characteristics and a plurality of transaction data entries, each transaction data entry corresponding to a payment transaction involving the related consumer;
a receiving device configured to receive a device profile, wherein the device profile includes device data corresponding to a computing device and a plurality of demographic characteristics associated with a specific consumer associated with the corresponding computing device; and
a processing device configured to
identify at least one consumer profile of the plurality of consumer profiles where at least a predefined number of the included plurality of consumer characteristics correspond to the plurality of demographic characteristics, and
associate, in the database, each of the identified at least one consumer profile with the device data included in the received device profile.

17. The system of claim 16, wherein the plurality of consumer characteristics includes at least one of: age, gender, income, marital status, familial status, residential status, occupation, education, zip code, postal code, street address, county, city, state, and country.

18. The system of claim 16, wherein each transaction data entry includes at least transaction data, a consumer identifier associated with the related consumer, and a merchant identifier associated with a merchant involved in the corresponding payment transaction.

19. The system of claim 18, wherein the transaction data includes at least one of: a transaction amount, product data, transaction time and/or date, geographic location, coupon data, and point-of-sale identifier.

20. The system of claim 16, wherein the plurality of consumer characteristics are not personally identifiable.

21. The system of claim 16, wherein the device data includes at least one of: an internet protocol address, a media access control address, a Bluetooth signature, a Wi-Fi signature, a local area network address, a serial number, a registration number, a device identifier, a manufacturer number, video data, audio data, streaming data, media consumption data, and device name.

22. The system of claim 16, wherein the plurality of demographic characteristics are not personally identifiable.

23. A system for distributing a linked consumer profile, comprising:
a database configured to store a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer;
a receiving device configured to receive a consumer profile request, wherein the consumer profile request includes at least a specific consumer identifier;
a processing device configured to identify, in the database, a specific consumer profile where the included consumer identifier corresponds to the specific consumer identifier; and
a transmitting device configured to transmit a request for device data, wherein the request for device data includes at least a predefined the plurality of consumer characteristics included in the identified specific consumer profile, wherein
the receiving device is further configured to receive device data,
the processing device is further configured to include, in the database, the received device data in the identified specific consumer profile, and
the transmitting device is further configured to transmit the specific consumer profile including the received device data in response to the transmitted device data request.

24. The system of claim 23, wherein the device data is associated with a plurality of demographic characteristics, and at least the predefined number of the plurality of consumer characteristics included in the specific consumer profile correspond to the plurality of demographic characteristics.

25. The system of claim 23, wherein the plurality of consumer characteristics includes at least one of: age, gender, income, marital status, familial status, residential status, occupation, education, zip code, postal code, street address, county, city, state, and country.

26. The system of claim 23, wherein each transaction data entry includes at least transaction data, a consumer identifier associated with the related consumer, and a merchant identifier associated with a merchant involved in the corresponding payment transaction.

27. The system of claim 26, wherein the transaction data includes at least one of: a transaction amount, product data, transaction time and/or date, geographic location, coupon data, and point-of-sale identifier.

28. The system of claim 23, wherein the plurality of consumer characteristics are not personally identifiable.

29. The system of claim 23, wherein the wherein the device data includes at least one of: an internet protocol address, a media access control address, a Bluetooth signature, a Wi-Fi signature, a local area network address, a serial number, a registration number, a device identifier, a manufacturer number, video data, audio data, streaming data, media consumption data, and device name.

30. The system of claim 23, wherein the plurality of demographic characteristics are not personally identifiable.
